(19) United States
(12) Patent Application Publication
(10) Pub. No.: US 2014/0320604 A1
(43) Pub. Date: Oct. 30, 2014

(54) REUSING A STANDALONE CAMERA AS PART OF A THREE-DIMENSIONAL (3D) CAMERA IN A DATA PROCESSING DEVICE

(71) Applicant: NVIDIA Corporation, Santa Clara, CA (US)

(72) Inventors: Anup Ashok Dalvi, Pune (IN); Dhaval Sanjaykumar Dave, Ahmedabad (IN)

(73) Assignee: NVIDIA Corporation, Santa Clara, CA (US)

(21) Appl. No.: 13/869,044

(22) Filed: Apr. 24, 2013

(51) Int. Cl. H04N 13/02

(52) U.S. Cl. CPC H04N 13/0289; H04N 13/0296
USPC 348/47

(57) ABSTRACT

A method includes providing a primary camera and a secondary camera in a data processing device. The primary camera and the secondary camera are both capable of capturing an image and/or a video frame of a same resolution. The method also includes enabling the secondary camera and the primary camera to be utilized as standalone cameras, and providing a capability to rotate the secondary camera from an angular position of utilization as the standalone camera to an angular position of utilization thereof in conjunction with the primary camera as a three-dimensional (3D) camera offering stereoscopic separation between the primary camera and the secondary camera.

### FIELD OF TECHNOLOGY

This disclosure relates generally to data processing devices and, more particularly, to a method, an apparatus and/or a device of reusing a standalone camera as part of a three-dimensional (3D) camera in a data processing device.

### BACKGROUND

A data processing device (e.g., a mobile phone) may have a low resolution camera at a portion thereof facing a user. The aforementioned low resolution camera may be employed in applications such as video-calling. Further, the data processing device may include a high resolution camera at a rear portion thereof. The high resolution camera may be employed in the capturing of images and/or video frames. In the case of a data processing device with a 3D camera, two high resolution cameras separated by a distance correlating to a distance between a right eye and a left eye of a human user may be provided in addition to the low resolution camera. Thus, expenses associated with an Original Equipment Manufacturer (OEM) may increase.

### SUMMARY

Disclosed are a method, an apparatus and/or a device of reusing a standalone camera as part of a three-dimensional (3D) camera in a data processing device.

In one aspect, a method includes a primary camera and a secondary camera in a data processing device. The primary camera and the secondary camera are both capable of capturing an image and/or a video frame of a same resolution. The method also includes enabling the secondary camera and the primary camera to be utilized as standalone cameras, and providing a capability to rotate the secondary camera from an angular position of utilization as the standalone camera to an angular position of utilization thereof in conjunction with the primary camera as a 3D camera offering stereoscopic separation between the primary camera and the secondary camera.

In another aspect, a data processing device includes a primary camera and a secondary camera. The primary camera and the secondary camera both are capable of capturing an image and/or a video frame of a same resolution. The primary camera and the secondary camera are capable of being utilized as standalone cameras. The secondary camera has a rotation mechanism associated therewith to enable rotation of the secondary camera from an angular position of utilization as the standalone camera to an angular position of utilization thereof in conjunction with the primary camera as a 3D camera offering stereoscopic separation between the primary camera and the secondary camera.

In yet another aspect, a non-transitory medium, readable through a data processing device and including instructions embodied therein that are executable through the data processing device, is disclosed. The non-transitory medium includes instructions to enable utilization of a primary camera and a secondary camera as standalone cameras on the data processing device. The primary camera and the secondary camera both are capable of capturing an image and/or a video frame of a same resolution. The non-transitory medium also includes instructions to provide a capability to rotate the secondary camera from an angular position of utilization as the standalone camera to an angular position of utilization thereof in conjunction with the primary camera as a 3D camera offering stereoscopic separation between the primary camera and the secondary camera.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of an example camera configuration of the data processing device of FIG. 1.

FIG. 3 is a schematic view of an alternate camera configuration of the data processing device of FIG. 1.

FIG. 4 is a schematic view of another alternate camera configuration of the data processing device of FIG. 1.

FIG. 5 is a schematic view of interaction between a driver component and a standalone camera of the data processing device of FIG. 1, according to one or more embodiments.

FIG. 6 is a schematic view of an example rotation mechanism of the standalone camera of the data processing device of FIG. 1.

FIG. 7 is a process flow diagram detailing the operations involved in reusing the standalone camera of the data processing device of FIG. 1 as part of a three-dimensional (3D) camera thereof, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device of reusing a standalone camera as part of a three-dimensional (3D) camera in a data processing device. Although the present embodiments have been described with reference to specific example embodiments, it will be evident that various modifications and changes may be made to these embodiments without departing from the broader spirit and scope of the various embodiments.

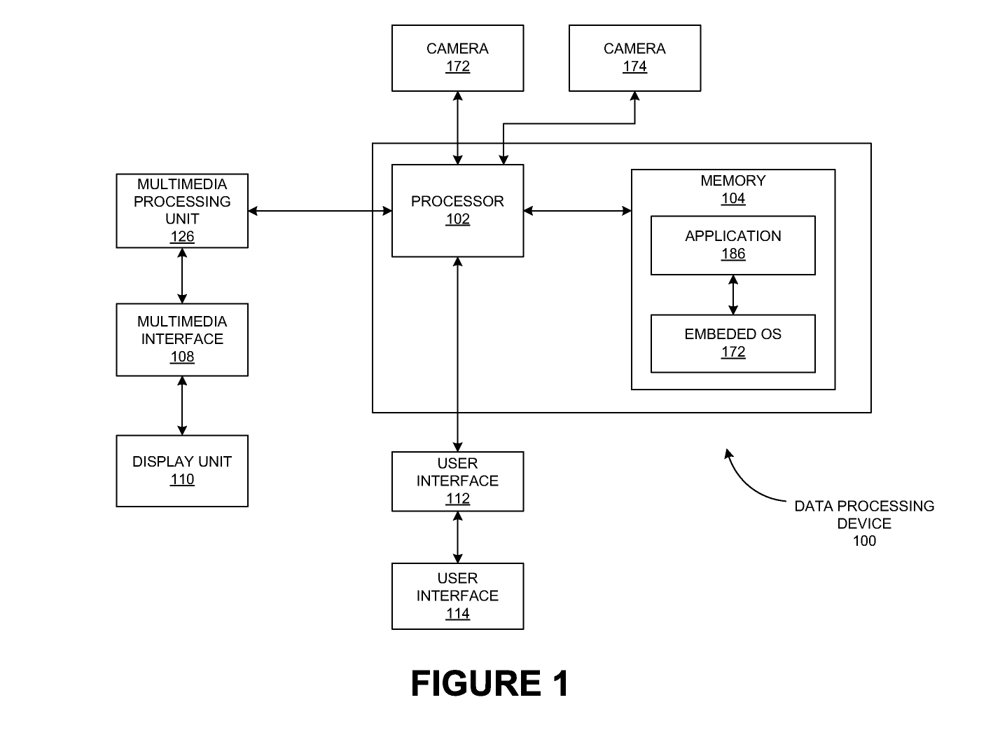

FIG. 1 shows a block diagram of a data processing device 100, according to one or more embodiments. In one or more embodiments, data processing device 100 may be a portable device (e.g., a mobile phone) or even a laptop, a desktop Personal Computer (PC), a notebook computer, a netbook and the like. In one or more embodiments, data processing device 100 may include a processor 102 (e.g., a Graphics Processing Unit (GPU), a microprocessor, a central processor such as a Central Processing Unit (CPU)) communicatively coupled to a memory 104 (e.g., volatile memory and/or a non-volatile memory). In one or more embodiments, memory 104 may include storage locations configured to be addressable through processor 102.

In one or more embodiments, an embedded operating system (e.g., embedded OS 172) may execute on data processing device 100. FIG. 1 shows operating system (e.g., embedded OS 172) instructions as being stored in memory 104. Embedded operating system(s) (e.g., Windows® Embedded Compact (WinCE), Palm OS®, Android™, Apple®'s iOS®) may be preferentially utilized in exemplary embodiments when data processing device 100 is a mobile phone. Also, it is obvious that non-embedded operating system(s) may execute on data processing device 100 when data processing device 100, for example, is a laptop or a desktop PC.

In one or more embodiments, output data associated with processing through processor 102 may be input to a multimedia processing unit 126 configured to perform encoding/decoding associated with the data. In one or more embodiments, the output of multimedia processing unit 126 may be rendered on a display unit 110 (e.g., Liquid Crystal Display (LCD) display, Cathode Ray Tube (CRT) monitor) through a multimedia interface 108 configured to convert data to an appropriate format required by display unit 110.

In one or more embodiments, a user interface 112 (e.g., a Universal Serial Bus (USB) port) interfaced with processor 102 may be provided in data processing device 100 to enable coupling of a user input device 114 to processor 102 therethrough. In one or more embodiments, user input device 114 may include a keyboard/keypad and/or a pointing device (e.g., mouse, touchpad). In one or more embodiments involving a data processing device 100 such as a laptop or a notebook, a touchpad may be provided in proximity to a keyboard/keypad on a plane utilized for user input.

In one or more embodiments, data processing device 100 may include at least two cameras (e.g., camera 172 and camera 174 coupled to processor 102; the aforementioned cameras may be regarded as input devices and/or sensors; camera 172 and camera 174 may also be coupled to processor 102 through an interface) to capture three-dimensional (3D) images/videos therethrough. In the case of the cameras capturing videos, processor 102 may be configured to perform appropriate processing (e.g., encoding video frames in a sequence) associated therewith. FIG. 1 shows two cameras, viz. camera 172 and camera 174, as a preferred embodiment. In a typical mobile phone, a camera located on a plane facing a user thereof (or, front facing) may be of a low resolution and the rear facing camera may be of high resolution. The front camera, for example, may be employed in applications such as video-calling and the rear camera may be utilized during capturing of videos and high resolution images. In the typical solution, processor 102 may not offer support for two high resolution cameras.

In 3D cameras, there may be two cameras employed where the distance between lenses thereof approximately corresponds to the distance between a left eye and a right eye (e.g., 6.35 cm) of a human user. Such an arrangement may allow for stereoscopic separation between the images captured. Each camera may have a separate image sensor therein. The stereoscopic images captured may be composited (e.g., through processor 102) and rendered on display unit 110 to provide for a 3D effect to a user of data processing device 100.

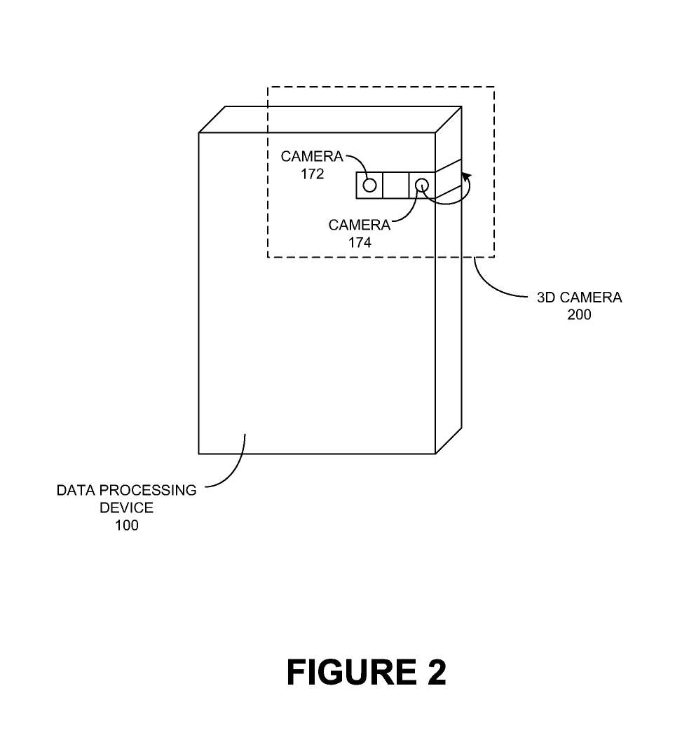

In the case of mobile phones with a 3D camera, the front facing camera may still be of low resolution and the 3D camera may be rear-facing. FIG. 2 shows an example camera configuration including camera 172 and camera 174 of data processing device 100. Here, camera 172 may be a primary camera having high resolution utilized in the capturing of high-resolution images and videos. Camera 174 may be the secondary camera utilized in video calls and other applications; however, camera 174 may offer the same resolution (or, a comparable resolution; for example, camera 172 and camera 174 may support different ranges of resolutions but the captured images may be of the same resolution; camera 174 may be of a lower resolution and camera 172 may be of a higher resolution but the captured images may be of the same lower resolution of camera 174) as the primary camera. In one or more embodiments, camera 174 may also be rotatable such that camera 174 (secondary camera) becomes part of a 3D camera setup with camera 172 (primary camera). In FIG. 2, the secondary camera, viz. camera 174 may be facing a user. In this state, camera 174 may be configured to be utilized during applications such as video-calling.

When the user performs an action related to initiation of utilization of data processing device 100 for, say, capturing high-resolution 3D images/videos, camera 174 may automatically rotate toward a rear side (180 degrees away from the front-side) of data processing device 100 such that camera 172 and camera 174 form a 3D camera 200 setup having stereoscopic separation capability. Here, camera 172 may be fixed and camera 174 may be rotatable around an axis along a length of the mobile phone. Alternately, both camera 172 and camera 174 may be rotatable. It is easy to note that when camera 172 and camera 174 are utilized as standalone cameras, lenses thereof are 180 degrees away from each other. In the state of the mobile phone being capable of capturing 3D images/videos, lenses of camera 172 and camera 174 may be 0 degrees away from each other.

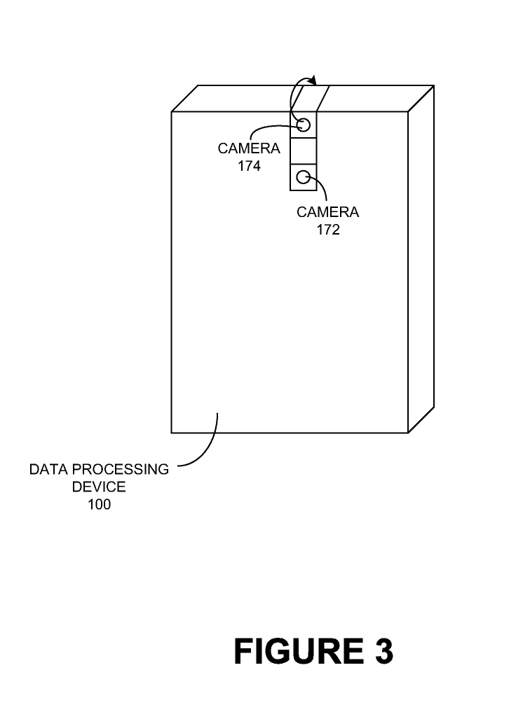

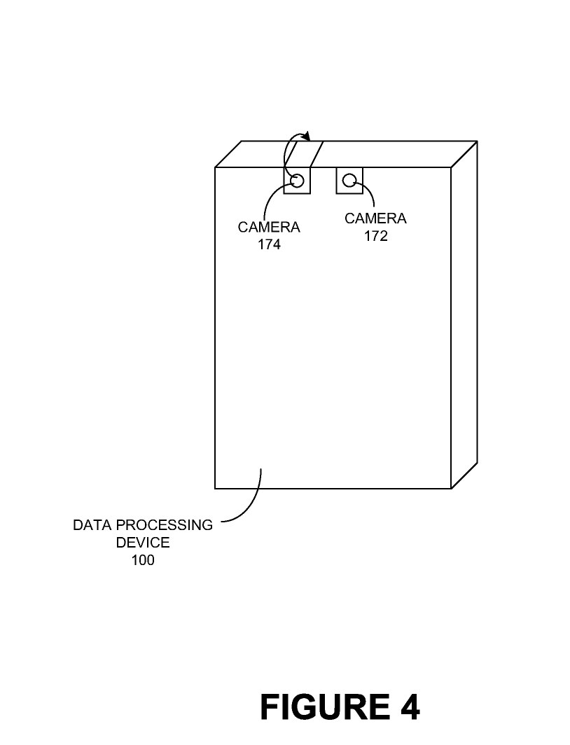

It should be noted that the angular separation between camera 172 and camera 174 in the state of being standalone devices is not limited to 180 degrees. Other angles are within the scope of the exemplary embodiments discussed herein. Moreover, the location of camera 172 and camera 174 are not restricted to the example of FIG. 2. FIGS. 3-4 demonstrate alternate implementations. It is obvious that other implementations are within the scope of the exemplary embodiments discussed herein.

The action related to initiation of utilization of data processing device 100 in the 3D mode thereof may involve the user clicking a camera application (e.g., application 186 is shown as being stored in memory 104; application 186 is configured to execute on processor 102/data processing device 100) through a user interface (e.g., touchscreen) of data processing device 100. Alternately, data processing device 100 may have a physical button that is configured to be pressed to transit to the 3D mode. The user may also initiate an action using the keyboard/keypad keys of data processing device 100. All forms of initiation are within the scope of the exemplary embodiments.

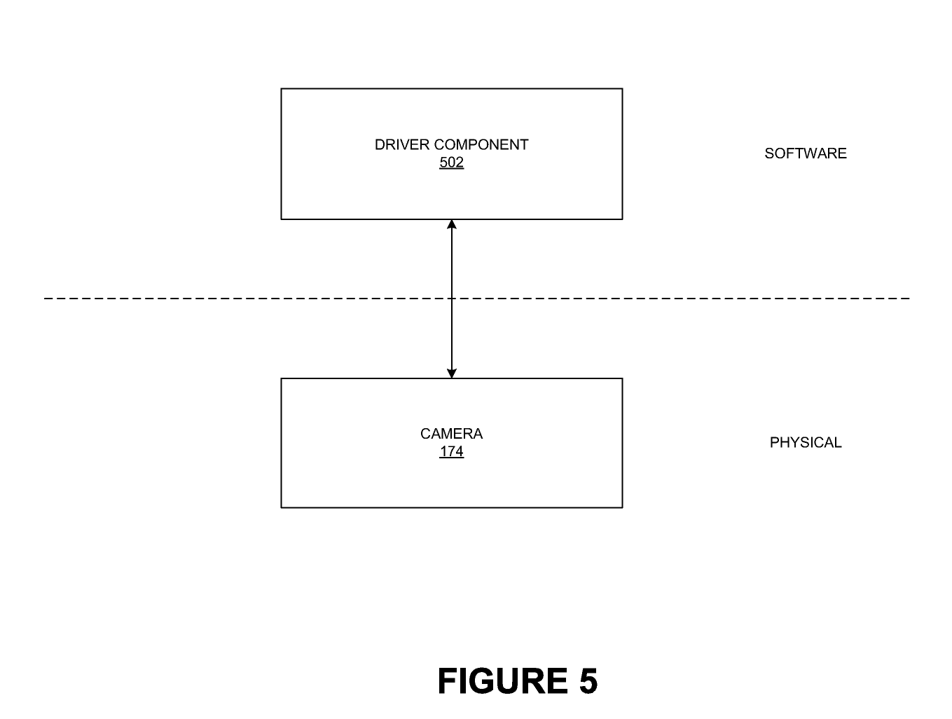

FIG. 5 shows interaction between a driver component 502 (e.g., a set of instructions) and camera 174 (and/or camera 172), according to one or more embodiments. In one or more embodiments, an Original Equipment Manufacturer (OEM) associated with data processing device 100 may define compatibility of camera 174 and/or camera 172 with processor 102. In one or more embodiments, the compatibility may be provided through driver component 502; driver component 502 may be associated with camera 174 or processor 102. Alternately, driver component 502 may be packaged with embedded OS 172 or application 186. Instructions associated with driver component 502 may also be tangibly embodied on a non-transitory medium (e.g., Compact Disc (CD), Digital Video Disc (DVD), hard drive; appropriate files may be downloaded to the hard drive) readable through data processing device 100.

In one or more embodiments, once the user initiates the action related to capturing 3D images/videos through data processing device 100 (e.g., by depressing a physical button, clicking application 186), driver component 502 may initiate execution instructions related to effecting a physical rotation of camera 174 to align with camera 172 as part of 3D camera 200 through processor 102. For example, rotation of camera 174 may be made possible through the provision of a motor (not shown) associated therewith that is configured to be circuit-controlled (and, in turn, driver and processor 102 controlled). Other forms of controlling rotation of camera 174 and/or camera 172 are within the scope of the exemplary embodiments.

Thus, in one or more embodiments, OEM expenses associated with providing an additional high-resolution camera in data processing device 100 may be reduced as the same standalone camera 174 may be employed in 3D camera 200; a low-resolution camera on the front-side may, therefore, be dispensed with. Further, exemplary embodiments are compatible with improved versions of processor 102 that support multiple high resolution cameras.

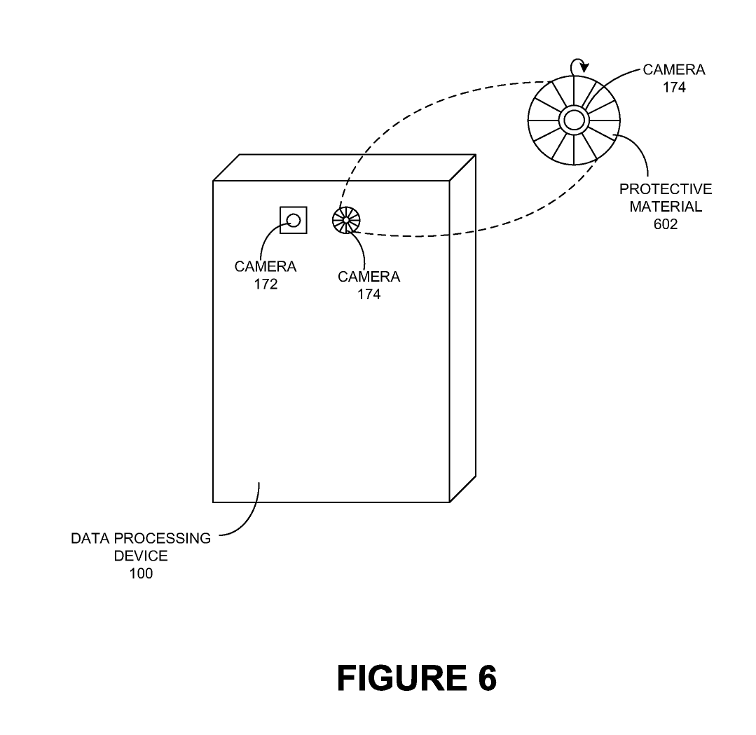

FIG. 6 shows an example rotation mechanism of camera 174 (or, camera 172). Here, camera 174 may be surrounded by a layer of protective material 602 such as rubber (other materials are within the scope of the exemplary embodiments). Protective material 602 may be elevated to protect a lens of camera 174 from being touched by a finger of the user. The user may scroll camera 174 in a direction shown in FIG. 6 such that camera 174 shifts from a position of secondary use thereof to being a part of 3D camera 200. Here, camera 174 (or camera 172) may rotate around an axis perpendicular to a length of data processing device 100 (mobile phone). It is obvious that protective material 602 may also be cylindrical in shape; other forms are within the scope of the exemplary embodiments discussed herein.

It should be noted that the user may scroll camera 174 manually to shift camera 174 between a position of secondary use thereof and a position of being part of 3D camera 200. Both manual (e.g., all reasonable example rotation mechanisms) and automatic forms of camera movement are within the scope of the exemplary embodiments discussed herein.

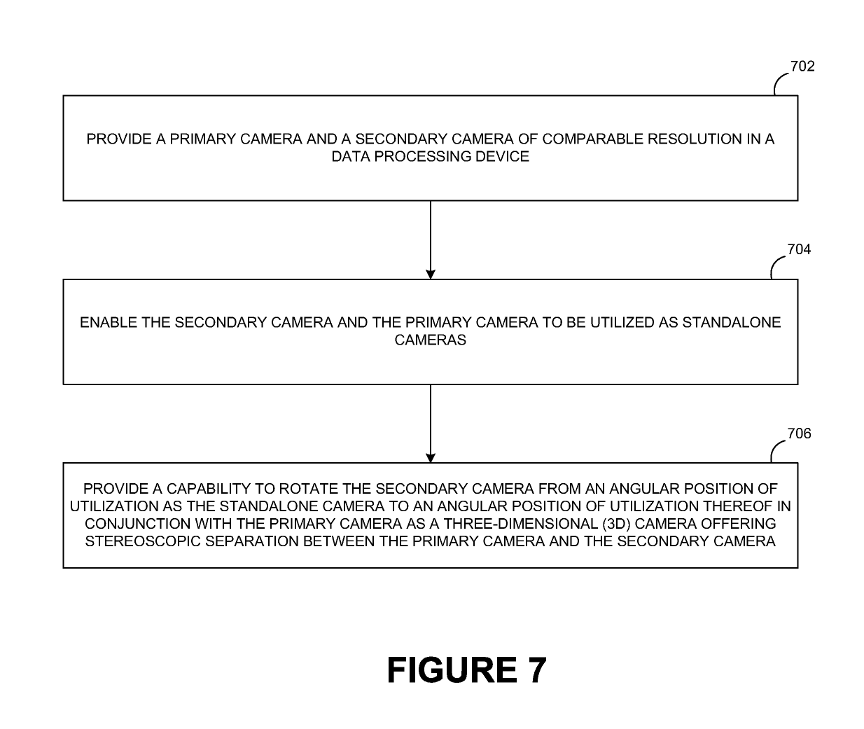

FIG. 7 shows a process flow diagram detailing the operations involved in reusing a standalone camera 174 as part of 3D camera 200 in data processing device 100, according to one or more embodiments. In one or more embodiments, operation 702 may involve providing a primary camera (e.g., camera 172) and a secondary camera (e.g., camera 174) in data processing device 100. In one or more embodiments, camera 172 and camera 174 may both be capable of capturing an image and/or a video frame of a same resolution. In one or more embodiments, operation 704 may involve enabling camera 172 and camera 174 to be utilized as standalone cameras. In one or more embodiments, operation 706 may then involve providing a capability to rotate camera 174 from an angular position of utilization as the standalone camera to an angular position of utilization thereof in conjunction with camera 172 as a 3D camera offering stereoscopic separation between camera 172 and camera 174.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 100). Accordingly, the specification and drawings are to be regarded in an illustrative rather than a restrictive sense.

What is claimed is:

1. A method comprising:
providing a primary camera and a secondary camera in a data processing device, the primary camera and the secondary camera both being capable of capturing at least one of an image and a video frame of a same resolution;
enabling the secondary camera and the primary camera to be utilized as standalone cameras; and
providing a capability to rotate the secondary camera from an angular position of utilization as the standalone camera to an angular position of utilization thereof in conjunction with the primary camera as a three-dimensional (3D) camera offering stereoscopic separation between the primary camera and the secondary camera.

2. The method of claim 1, wherein providing the capability to rotate the secondary camera includes at least one of:
enabling manual rotation of the secondary camera through an appropriate mechanism provided therefor; and
configuring, through a driver component in conjunction with a processor of the data processing device, the rotation of the secondary camera.

3. The method of claim 1, further comprising providing a capability to rotate the primary camera in addition to the secondary camera.

4. The method of claim 1, comprising providing a capability to rotate the secondary camera about an axis one of: along a length of the data processing device and perpendicular to the length of the data processing device.

5. The method of claim 1, wherein the data processing device is a mobile phone.

6. The method of claim 1, further comprising initiating utilization of the 3D camera of the data processing device one of: through clicking a camera application executing on the data processing device, through a user interface of the data processing device, utilizing one of a keyboard and a keypad of the data processing device and depressing a physical button on the data processing device.

7. The method of claim 2, comprising providing the driver component as one of:
packaged with an operating system executing on the data processing device, packaged with an application executing on the data processing device, associated with the secondary camera of the data processing device and associated with the processor of the data processing device.

8. A data processing device comprising:
a primary camera; and
a secondary camera, the primary camera and the secondary camera both being capable of capturing at least one of an image and a video frame of a same resolution, the primary camera and the secondary camera being capable of being utilized as standalone cameras, and the secondary camera having a rotation mechanism associated therewith to enable rotation of the secondary camera from an angular position of utilization as the standalone camera to an angular position of utilization thereof in conjunction with the primary camera as a 3D camera offering stereoscopic separation between the primary camera and the secondary camera.

9. The data processing device of claim 8, further comprising:
a processor communicatively to a memory; and
a driver component to configure the rotation of the secondary camera in conjunction with the processor.

10. The data processing device of claim 8, further comprising another rotation mechanism to enable rotation of the primary camera in addition to the secondary camera.

11. The data processing device of claim 8, wherein the rotation mechanism enables the rotation of the secondary camera about an axis one of: along a length of the data processing device and perpendicular to the length of the data processing device.

12. The data processing device of claim 8, wherein the data processing device is a mobile phone.

13. The data processing device of claim 8, further comprising at least one of:
a camera application executing on the data processing device;
a user interface of the data processing device;
one of a keyboard and a keypad of the data processing device; and
a physical button on the data processing device
to initiate utilization of the 3D camera of the data processing device.

14. The data processing device of claim 9, wherein driver component is provided as one of: packaged with an operating system executing on the data processing device, packaged with an application executing on the data processing device, associated with the secondary camera of the data processing device and associated with the processor of the data processing device.

15. A non-transitory medium, readable through a data processing device and including instructions embodied therein that are executable through the data processing device, comprising:
instructions to enable utilization of a primary camera and a secondary camera as standalone cameras on the data processing device, the primary camera and the secondary camera both being capable of capturing at least one of an image and a video frame of a same resolution; and
instructions to provide a capability to rotate the secondary camera from an angular position of utilization as the standalone camera to an angular position of utilization thereof in conjunction with the primary camera as a 3D camera offering stereoscopic separation between the primary camera and the secondary camera.

16. The non-transitory medium of claim 15, comprising at least one of:
instructions compatible with manual rotation of the secondary camera through an appropriate mechanism provided therefor; and
instructions to configure, through a driver component in conjunction with a processor of the data processing device, rotation of the secondary camera.

17. The non-transitory medium of claim 15, further comprising instructions to provide a capability to rotate the primary camera in addition to the secondary camera.

18. The non-transitory medium of claim 15, comprising instructions to provide a capability to rotate the secondary camera about an axis one of: along a length of the data processing device and perpendicular to the length of the data processing device.

19. The non-transitory medium of claim 15, further comprising instructions to initiate utilization of the 3D camera of the data processing device one of: through clicking a camera application executing on the data processing device, through a user interface of the data processing device, utilizing one of a keyboard and a keypad of the data processing device and depressing a physical button on the data processing device.

20. The non-transitory medium of claim 16, comprising instructions compatible with providing the driver component as one of: packaged with an operating system executing on the data processing device, packaged with an application executing on the data processing device, associated with the secondary camera of the data processing device and associated with the processor of the data processing device.
